(19) United States
(12) Patent Application Publication
(10) Pub. No.: US 2015/0011186 A1
(43) Pub. Date: Jan. 8, 2015

(54) METHOD AND APPARATUS FOR DETECTING SMS-BASED MALWARE

(71) Applicant: ELECTRONICS AND TELECOMMUNICATIONS RESEARCH INSTITUTE, Daejeon (KR)

(72) Inventors: Seung-Yong YOON, Daejeon (KR); Young-Sae KIM, Daejeon (KR); Jeong-Nyeo KIM, Daejeon (KR); Hyun-Sook CHO, Daejeon (KR); Hong-Il JU, Daejeon (KR)

(21) Appl. No.: 14/321,955

(22) Filed: Jul. 2, 2014

(30) Foreign Application Priority Data
Jul. 5, 2013 (KR) 10-2013-0079270
Jun. 2, 2014 (KR) 10-2014-0067080

(51) Int. Cl. H04W 12/02; H04W 4/14

(52) U.S. Cl. CPC H04W 12/02; H04W 4/14
USPC 455/410

(57) ABSTRACT

There are provided a method and apparatus for detecting and handling a malicious act that performs billing and takes a financial gain using a short message service (SMS) in real time. The apparatus includes an SMS collecting module configured to collect an SMS message sent from or received in a smartphone; an SMS parsing module configured to parse the collected SMS message; an SMS examining module configured to examine at least one field of the parsed SMS message and determine whether the SMS message is a malicious act-related message based on an access control list (ACL) and an SMS signature DB; and an installing app examining module configured to examine SMS message sending permission of an app to be installed in the smartphone and a priority of an SMS receiver process included in the app and determine whether the app has a possibility of being malware.

### CROSS-REFERENCE TO RELATED APPLICATION

This application claims priority to and the benefit of Korean Patent Application Nos. 10-2013-0079270, filed on Jul. 5, 2013 and 10-2014-0067080, filed on Jun. 2, 2014, the disclosures of which are incorporated herein by reference in their entirety.

### BACKGROUND

1. Field of the Invention

The present invention relates to detection of smartphone malware, and specifically, to a method and apparatus for detecting and handling malware that performs billing and takes a financial gain using a short message service (SMS) in real time.

2. Discussion of Related Art

Smartphone markets have seen tremendous growth in the last few years, and smartphone malware is also quickly increasing in terms of a scale. This is because an open environment of an open platform and an open market in which any one can create and distribute malware with ease. In addition, the malware can be easily distributed due to various external access environments such as wireless Internet (Wi-Fi), Bluetooth, and USB.

Initial smartphone malware aimed to simple distribution or stop functional operations of terminals. Recently, malware is being changed to forms that leak personal information and acquire financial gain by performing billing. In particular, as smishing methods are generalized, malware using an SMS message is frequently emerging. Representatively, there are an attack using micropayment vulnerability, a premium rate service attack, an excessive SMS sending attack, a distributed denial of service (DDoS) attack, and the like.

However, currently, in order to detect the malware, most smartphones use vaccine programs as in existing PCs, and perform a signature-based pattern matching method on malware samples. Such a detecting method has difficulty detecting and handling mobile malware, which is becoming more intelligent such as smishing. In particular, in order to more accurately and quickly detect and handle in real time malware that performs billing using the SMS, which is evolving into a sophisticated mechanism, it is necessary to examine a process of installing the malware and a process of sending and receiving the SMS message more thoroughly, in addition to a simple signature examination of malware samples.

### SUMMARY OF THE INVENTION

The present invention provides a method and apparatus for detecting malware that performs a malicious act using an SMS.

Specifically, the present invention provides a method and apparatus capable of preventing billing through the SMS in a smartphone by collecting and examining all SMS messages sent from or received in the smartphone to detect a malicious act.

In addition, the present invention provides a method and apparatus capable of blocking installation of an app as necessary by examining whether the app is likely to perform an SMS-based malicious act when the app is installed in the smartphone.

According to an aspect of the present invention, there is provided an apparatus for detecting SMS-based malware. The apparatus includes an SMS collecting module configured to collect an SMS message sent from or received in a smartphone; an SMS parsing module configured to parse the collected SMS message; an SMS examining module configured to examine at least one field of the parsed SMS message and determine whether the SMS message is a malicious act-related message based on an access control list (ACL) and an SMS signature DB; and an installing app examining module configured to examine SMS message sending permission of an app to be installed in the smartphone and a priority of an SMS receiver process included in the app and determine whether the app has a possibility of being malware. In an embodiment, the ACL may include at least one among a phone number of a premium rate service, a phone number of a command and control server, and a phone number of a smartphone that is already infected with the malware.

The SMS signature DB may store at least one among a phone number of the smartphone that is already infected with the malware, a micropayment certification number caused by a malicious act, subscription information, subscription confirming information, auto-response information, and billing-related information that are sent and received during a premium rate service attack process, and DDoS attack command information.

The SMS examining module may measure the number of sent or received SMS messages per unit time to detect execution of the malware in the smartphone.

The apparatus may further include a user determination module configured to receive decision from a user on whether the SMS message determined as the malicious act-related message is blocked and whether the app determined as having a possibility of being malware is deleted.

The apparatus may further include an SMS filtering module configured to block sending or receiving of the message determined as the malicious act-related message according to the user's decision to block.

The apparatus may further include an app deleting module configured to delete the app according to the user's decision to delete the app.

According to another aspect of the present invention, there is provided a method of detecting SMS-based malware. The method includes collecting an SMS message sent from or received in a smartphone; parsing the collected SMS message; examining at least one field of the parsed SMS message and determining whether the SMS message is a malicious act-related message based on an ACL and an SMS signature DB; and examining SMS message sending permission of an app to be installed in the smartphone and a priority of an SMS receiver process included in the app and determining whether the app has a possibility of being malware.

The ACL may include at least one among a phone number of a premium rate service, a phone number of a command and control server, and a phone number of a smartphone that is already infected with the malware.

The SMS signature DB may store at least one among a phone number of the smartphone that is already infected with the malware, a micropayment certification number caused by a malicious act, subscription information, subscription confirming information, auto-response information, and billing-related information that are sent and received during a premium rate service attack process, and DDoS attack command information.

The method may further include measuring the number of sent SMS messages per unit time; and determining the SMS message as the malicious act-related message when the number of SMS messages sent to the same destination phone number per unit time exceeds a first threshold.

The method may further include measuring the number of received SMS messages per unit time; and determining the SMS message as the malicious act-related message when the number of received SMS messages per unit time exceeds a second threshold.

The method may further include allowing a user to determine whether the message is blocked when the SMS message is determined as the malicious act-related SMS message.

The method may further include allowing a user to determine whether the app is deleted when it is determined that the app to be installed has a possibility of being malware.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 illustrates an attack process using micropayment vulnerability;

FIG. 2 illustrates a process of performing a premium rate service attack using an SMS message;

FIG. 3 illustrates a process of an excessive SMS sending attack;

FIG. 4 illustrates a process of a DDoS attack using the SMS message;

FIG. 5 is a block diagram illustrating a structure of an apparatus for detecting SMS-based malware according to an embodiment of the present invention;

FIG. 6 is a flowchart illustrating an SMS-based malware detecting method according to an embodiment of the present invention;

FIG. 7 illustrates a process of determining whether a sent SMS message is associated with a malicious act according to an embodiment of the present invention;

FIG. 8 illustrates a process of determining whether a received SMS message is associated with a malicious act according to an embodiment of the present invention;

FIG. 9 illustrates a process of determining whether an app to be installed has a possibility of being malware according to an embodiment of the present invention; and

FIG. 10 is a block diagram illustrating a configuration of a smartphone to which an embodiment of the present invention may be applied.

### DETAILED DESCRIPTION OF EXEMPLARY EMBODIMENTS

While the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

In description of the invention, when it is determined that detailed descriptions of related well-known technology may unnecessarily obscure the gist of the invention, detailed descriptions thereof will be omitted.

In addition, the singular forms used in the specification and claims are interpreted to include plural forms as well, unless otherwise indicated.

Terms used in the specification such as “module,” “unit,” and “interface,” generally refer to computer related objects, and may refer to, for example, hardware, software, and combinations thereof.

First, to help understanding of the present invention, four types of representative SMS -based malware attacks will be described.

1. Attack Using Micropayment Vulnerability

Many online payment sites in Korea support a micropayment. The micropayment includes two certification processes. First, primary user certification is performed using a social security number and a phone number of a smartphone subscriber, operator information, and the like. Second, secondary certification is performed using a certification letter sent to a smartphone that applies the micropayment. When the certification letter received in the smartphone is input in a payment window, the payment is completed. Unlike existing feature phones, since a user of the smartphone may install any app in the smartphone and have vulnerability enabling the installed app to access an SMS message, problems may occur in the micropayment method.

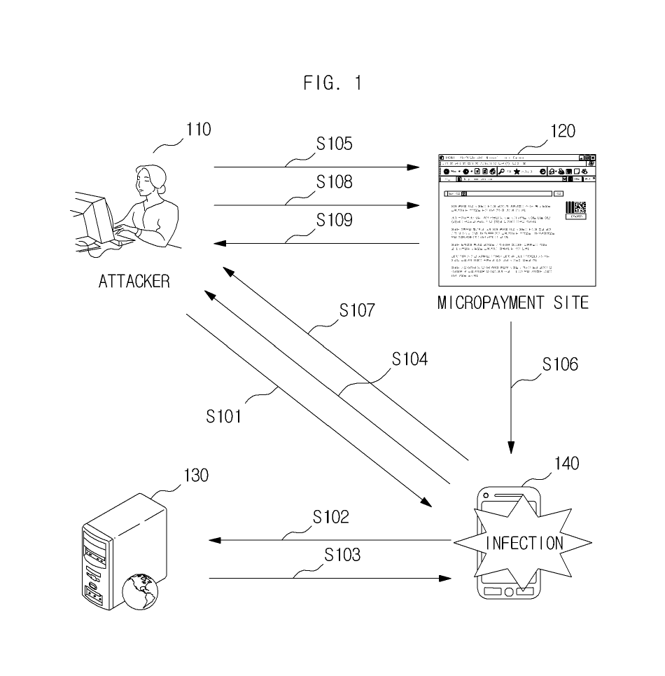

FIG. 1 illustrates an attack process using micropayment vulnerability.

As illustrated in FIG. 1, an attacker 110 sends a smishing SMS message to an attack target using personal information obtained in advance (S101).

The user innocently clicks a link of the SMS, accesses malware provided at site 130, and downloads the malware to a smartphone 140 (S102).

The malware is installed in the smartphone 140 and the smartphone is infected. Therefore, the smartphone 140 is a zombie-state smartphone (S103).

The infected smartphone 140 sends the phone number and the operator information to the attacker 110 (S104).

The attacker 110 inputs the social security number among the personal information obtained in advance and a phone number of the infected smartphone to a micropayment site 120 (S105).

The micropayment site 120 sends an SMS message including a certification number to the infected smartphone 140 (S106).

When the SMS message including the certification number is received, the infected smartphone 140 intercepts the SMS, does not show the SMS to the user, and sends the SMS to the attacker 110 (S107).

The attacker 110 inputs the certification number of the received SMS to the micropayment site 120 (S108).

The attacker 110 completes a normal payment procedure in the micropayment site 120 and completes to purchase a cash redeemable product (S109).

In this way, since illegal processes of sending and receiving the SMS (S104, S106, and S107) are performed without the user's knowledge, the user may have a financial loss without being aware of it.

In order to detect such types of attacks, when the process of downloading and installing the malware (S104), the process of sending the illegal SMS to the attacker (S104 and S107), and the process of receiving the certification letter in the micropayment site (S106) are carefully examined, it is possible to detect the attack.

2. Premium Rate Service Attack

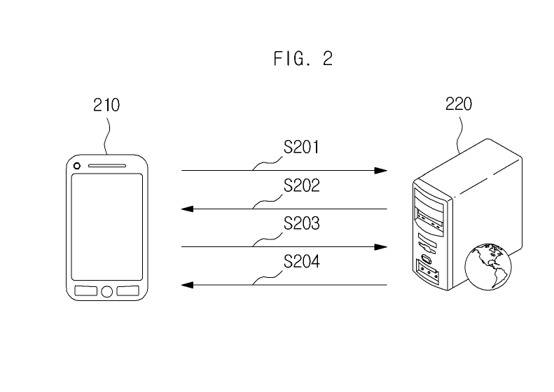

A premium rate service attack is widely used in the US, Russia, China, and the like, rather than Korea. The attacker registers a premium rate service in advance. When the SMS message is received, a billing premium number is assigned. Then, malware that sends the SMS to a corresponding number is created and distributed. When the infected smartphone sends the SMS message to the premium number, the attacker takes an illegal financial gain by receiving the SMS. FIG. 2 illustrates a process of performing a premium rate service attack using an SMS message.

An infected smartphone 210 sends an SMS message subscribing to the premium rate service to the premium number of the attacker (S201).

A service provider 220 sends an SMS message confirming premium rate service subscription to the smartphone 210 (S202).

The infected smartphone 210 automatically creates a response for the confirmation SMS message “YES” or “Y” and sends the response to the service provider 220 (S203).

Then, a service provider sends a billing-related SMS message to the smartphone 210 (S204).

In such a process, sending and receiving of all SMS messages are performed without the user's knowledge. Due to the premium rate service attack, billing is performed and the user suffers a financial loss. In order to detect the attack, it is necessary to examine a premium rate service-related SMS message.

3. Excessive SMS Sending Attack

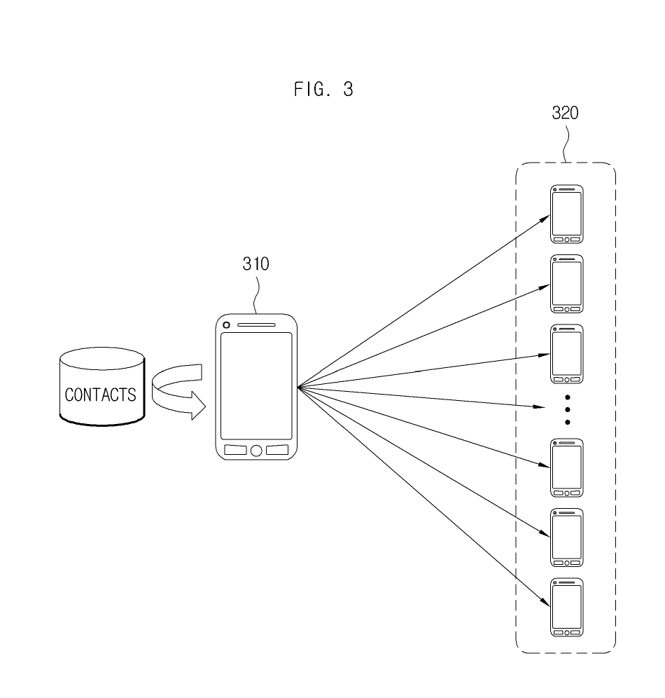

FIG. 3 illustrates a process of an excessive SMS sending attack. As illustrated in FIG. 3, the attacker reads contacts of an infected smartphone 310 and sends the SMS message in random to arbitrary phone numbers of the contacts registered in smartphones 320. As a result, the user suffers a financial loss due to billing caused by excessive SMS sending.

4. Distributed Denial of Service (DDoS) Attack

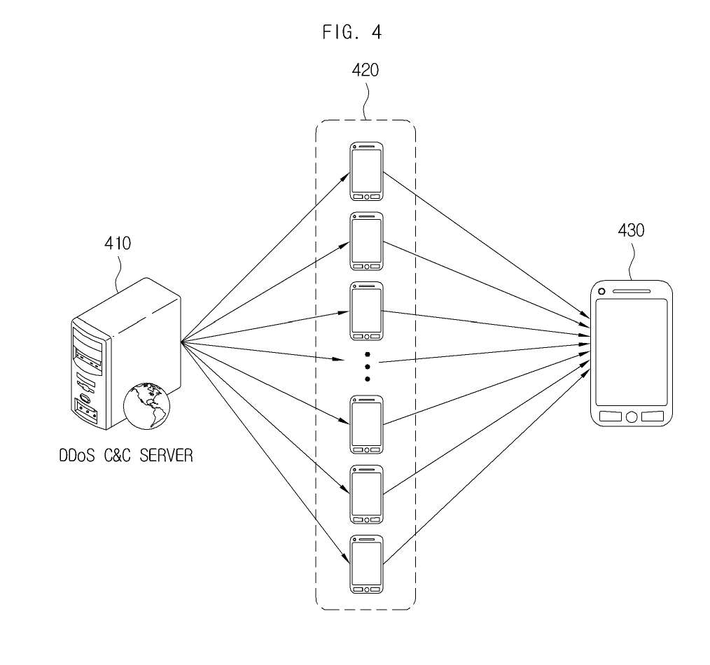

FIG. 4 illustrates a process of a DDoS attack using the SMS message. As illustrated in FIG. 4, a DDoS command and control (C&C) server 410 delivers a DDoS attack command to infected smartphones 420 using the SMS message. Therefore, the attacker may perform the DDoS attack by sending a plurality of SMS messages to other smartphones using an infected zombie-state smartphone. The zombie-state smartphone is used for the DDoS attack and the user suffers illegal billing The user of the damaged smartphone has difficulty in using an SMS service due to the DDoS attack.

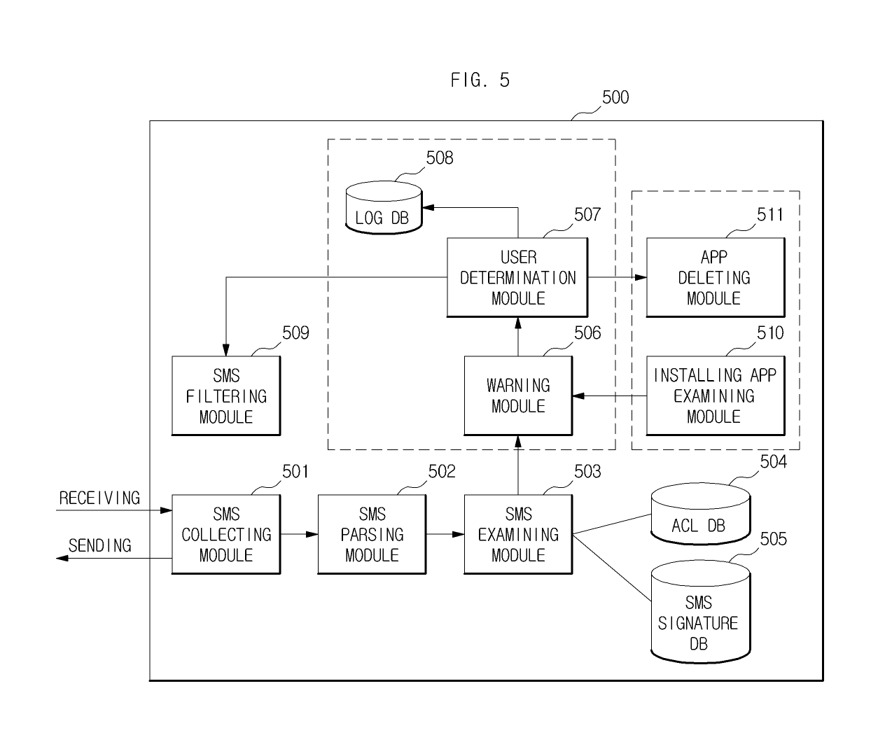

As described above, embodiments of the present invention to be described below relate to an apparatus and method for quickly detecting and handling the SMS-based malware in real time. Various embodiments of the present invention will be described with reference to FIGS. 5 to 10.

FIG. 5 is a block diagram illustrating a structure of an apparatus for detecting SMS-based malware according to an embodiment of the present invention. As illustrated in FIG. 5, an SMS-based malware detecting apparatus 500 may include at least some or all among an SMS collecting module 501, an SMS parsing module 502, an SMS examining module 503, an ACL DB 504, an SMS signature DB 505, a warning module 506, a user determination module 507, a log DB 508, an SMS filtering module 509, an installing app examining module 510, and an app deleting module 511.

The SMS collecting module 501 collects all SMS messages that are sent from or received in a smartphone. As described above, the attacker hides sending and receiving of the malicious act-related SMS message such that the user is not aware thereof. Therefore, the SMS collecting module 501 needs to collect all SMS messages the attacker intends to hide. For example, in order to collect a sent SMS message, the SMS collecting module 501 may monitor a sent box of “content://sms/out” using a content observer (ContentObserver) process. Meanwhile, in order to collect received SMS messages, the SMS collecting module 501 sets a priority of an SMS receiver process serving as a broadcast receiver to the highest value “999” and may collect all received SMS messages.

The SMS parsing module 502 parses the collected SMS message into individual fields. Basically, the SMS parsing module 502 extracts information such as a destination/source phone number, a sender/recipient, a date, a type, a status, a message body, and the like through a function getColumnIndex( ). The SMS examining module 503 uses these pieces of extracted information to examine a malicious act such as performing billing.

In one embodiment, the SMS examining module 503 examines at least one field of the SMS message parsed by the SMS parsing module 502 based on information registered in the ACL DB 504 and the SMS signature DB 505, and thus may determine whether the SMS message is an SMS message causing the malicious act.

In one embodiment, the SMS examining module 503 examines a source/destination phone number among fields included in the SMS message and may examine whether the number matches a premium phone number of the premium rate service attack that is previously registered in the ACL DB 504. The premium phone number may have a form that is hard-coded in the malware or may be downloaded in real time during execution. When the premium phone number is hard-coded, it may be easily detected by a vaccine program. Accordingly, in order to prevent such detection, hackers may allow a premium phone number to be downloaded to the smartphone in real time from an external hacking server while the malware executes. The ACL DB 504 updates and maintains any type of premium phone number with the most recent information. In addition, the ACL DB 504 may further include a phone number of the C&C server that controls the DDoS attack using the SMS and a phone number of the zombie-state smartphone that is already infected with the malware in addition to the premium phone number.

Also, by examining whether a body section (or content) of the SMS message has a signature related to the malicious act using the SMS signature DB 505, the SMS examining module 503 may examine whether the message is an SMS message causing the malicious act. For example, the operator information and the smartphone number infected during the attack process (S104) using micropayment vulnerability in FIG. 1, the certification number or an approval number string for the micropayment during the processes (S106 and S107), and the like may be stored in the SMS signature DB 505. In addition, subscription information, subscription confirming information, auto-response information, billing-related information, and the like that are sent during the premium rate service attack processes (S201 to S204) illustrated in FIG. 2 may be stored in the SMS signature DB 505. Also, DDoS attack command information delivered from the C&C server to the zombie-state smartphone through the SMS during the DDoS attack process illustrated in FIG. 4 may be stored in the SMS signature DB 505.

The SMS examining module 503 may detect execution of the malware in the smartphone by measuring the number of sent and received SMS messages per unit time. In one embodiment, the SMS examining module 503 measures the number of sent SMS messages per unit time and examines a target destination. When the number of SMS messages sent to the same destination phone number exceeds a first threshold, it may be determined that the SMS message is a malicious act-related message. For example, it may be determined that the corresponding smartphone has become the zombie-state smartphone and performs the excessive SMS sending attack or the DDoS attack.

In addition, the SMS examining module 503 measures the number of received SMS messages per unit time. When the number exceeds a second threshold, it may be determined that the SMS message is the malicious act-related message. For example, it may be determined that the corresponding smartphone excessively receives the SMS message due to the attack of the malware (for example, the DDoS attack).

When the SMS examining module 503 detects the malicious act-related SMS message, the warning module 506 may provide a notification message indicating the detection to the user. In one embodiment, notification may be provided through a window such as a pop-up window. The notification message may include content that the SMS message related to a type of malicious act is currently detected.

The user determination module 507 may receive decision of the user on whether to send or receive the malicious act-related SMS message. In one embodiment, the user determination module 507 may receive a final decision from the user in response to the notification message of the warning module 506.

When the user determines to block sending of the malicious act-related SMS message through the user determination module 507, the SMS filtering module 509 may delete the corresponding SMS and block sending of the message. Meanwhile, when it is determined that receiving the malicious act-related SMS message is blocked, the SMS filtering module 509 executes AbortBroadcast( ) such that the SMS message may not be delivered to an SMS receiving module of the malware created by the attacker.

In addition, detection of the malicious act-related SMS message, and determination of the user on whether to receive and send the message may be recorded in the log DB 508.

By examining SMS message sending permission of the app to be installed in the smartphone and the priority of the SMS receiver process included in the app, the installing app examining module 510 may examine whether the app is likely to perform the malicious act. In general, the malware is downloaded and installed in the smartphone by pretending to be a regular app. The installing app examining module 510 examines the app when the app is installed. In order for the app to send the SMS message, permission “SEND_SMS” needs to be set, and in order to receive the SMS, permission “RECEIVE_SMS” needs to be set. Also, in order to take a financial gain by performing billing using the SMS message, the attacker needs to hide the sent/received SMS message in order to prevent the user from being aware. For this purpose, the malware uses sendTextMessage( ) to send the SMS message in the background such that the user is not aware thereof. This is underlying vulnerability of an Android platform. The attacker may send the SMS message using such vulnerability without the user's knowledge. Meanwhile, in order to intercept the receiving SMS message without the user's knowledge, the malware obtains the receiving SMS message first by setting the priority (intent-filter priority) of the SMS receiver process to the highest value, and performs manipulation such that the user is not aware of reception of the SMS message by calling abortBroadcast( ) for preventing basically performed SMS message broadcasting. A greater number indicates a higher priority. In the Android, the priority is set in a range of −999 to 999. Permission information and priority information are defined in a manifest file (“AndroidManifest.xml”) of Android package files. The installing app examining module 510 examines the permission information and priority information defined in the manifest file and may determine whether the app is likely to perform the malicious act.

When it is determined that the app is likely to perform the malicious act, the warning module 506 may provide a notification message indicating the fact to the user. Therefore, the user determination module 507 may receive the user's final decision on whether to delete or install the app in response to the notification message of the warning module 506.

When deletion of the app is determined by the user through the user determination module 507, the app deleting module 511 deletes the app in the smartphone.

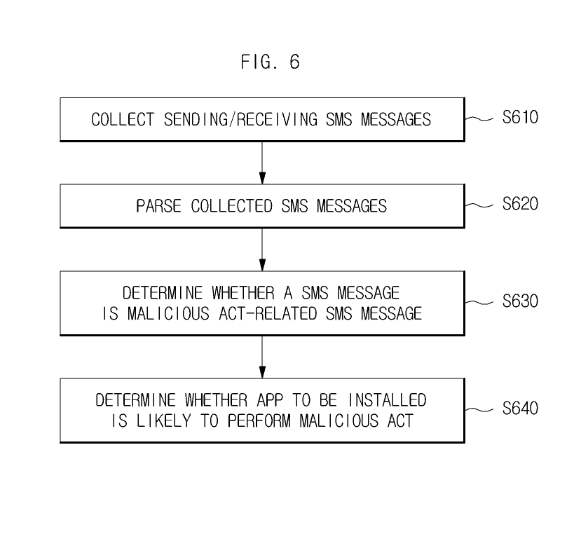

FIG. 6 is a flowchart illustrating an SMS-based malware detecting method according to an embodiment of the present invention.

The SMS message sent from or received in the smartphone is collected (S610), and the collected SMS message is parsed into individual fields (S620).

By examining at least one field of the parsed SMS message based on information registered in the ACL and the SMS signature DB, it is determined whether the SMS message is the malicious act-related SMS message (S630).

In one embodiment, the ACL includes at least one among a phone number of a premium rate service, a phone number of a command and control server, and a phone number of the smartphone that is already infected with the malware.

In one embodiment, the SMS signature DB stores at least one among the phone number of the smartphone that is already infected with the malware, a micropayment certification number caused by the malicious act, subscription information, subscription confirming information, auto-response information, and billing-related information that are sent and received during the premium rate service attack process, and DDoS attack command information as a signature of the malicious act.

In one embodiment, when an SMS message to be examined is determined as the malicious act-related SMS message, the user may determine whether to send or receive the message. Based on the user's decision, the message may be sent or the received SMS message may be delivered to a specific app or all apps installed in the smartphone.

By examining SMS message sending permission of the app to be installed in the smartphone and the priority of the SMS receiver process included in the app, it is determined whether the app is likely to perform the malicious act (S640).

In one embodiment, when it is determined that the app to be installed is likely to perform the malicious act, the user may determine whether to install the app. Based on the user's decision, the app may be deleted.

In FIG. 6, operations of S630 and S640 are sequentially illustrated for convenience of description, but it is apparent to those skilled in the art that the execution order thereof is not limited thereto.

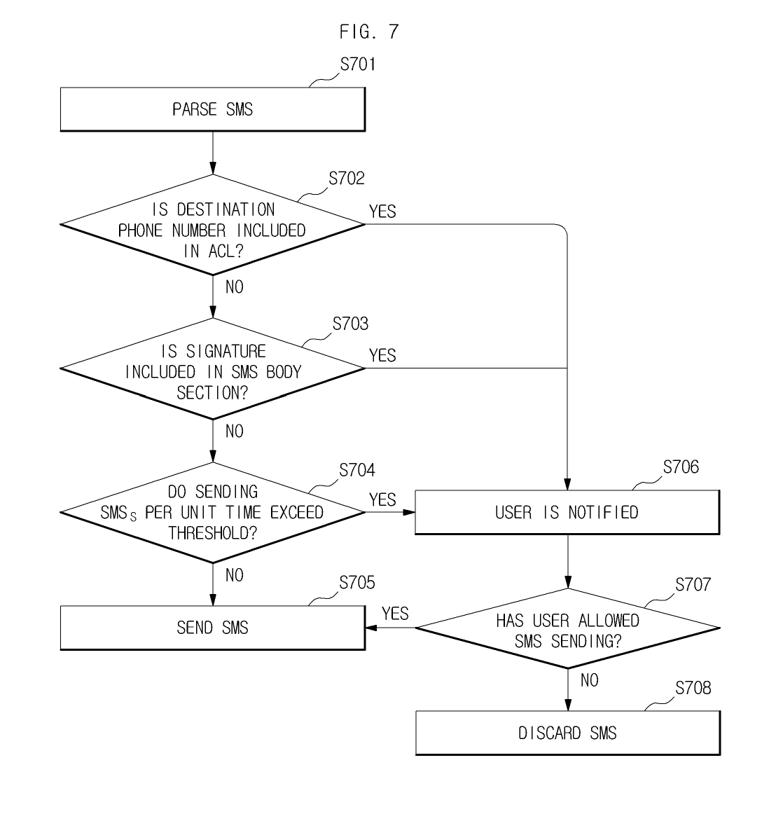

FIG. 7 illustrates a process of determining whether a sending SMS message is associated with a malicious act according to an embodiment of the present invention.

As illustrated in FIG. 7, after the SMS message is parsed (S701), it is determined whether the destination phone number is included in the ACL or the SMS body section includes a malicious act-related signature (S702 and S703). When the destination phone number is included in the ACL or the SMS body section includes the signature, the user is notified of the fact that the message is the malicious act-related message (S706).

It is determined whether the user allows the message to be sent. Based on the determination result, the SMS message is sent (S705) or discarded (S708).

In addition, the number of sent SMS messages per unit time is measured. When the measured number exceeds a threshold, the user may be notified of the fact that the malicious act-related SMS message is sent (S704 and S706).

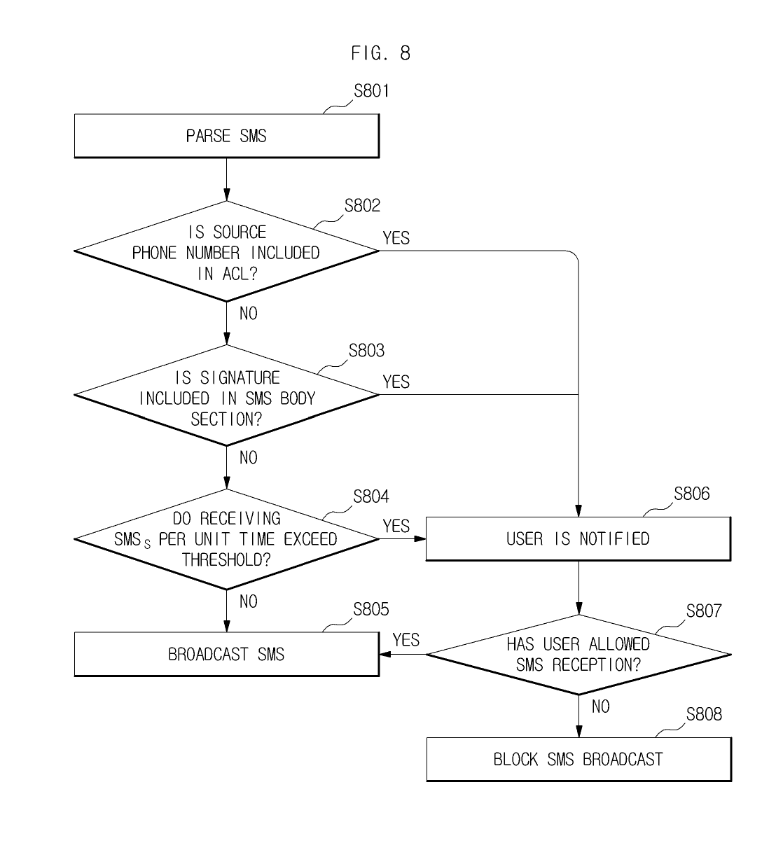

FIG. 8 illustrates a process of determining whether a receiving SMS message is associated with a malicious act according to an embodiment of the present invention.

After the SMS message is parsed (S801), it is determined whether the source phone number is included in the ACL or the SMS body section includes the malicious act signature (S802 and S803). When the source phone number is included in the ACL or the SMS body section includes the signature, the use is notified of the fact that the message is the malicious act-related message (S806).

It is determined whether the user allows the message to be received. Based on the determination result, the SMS message is broadcast to apps in the smartphone (S805), or broadcast of the message is blocked (S808).

In addition, the number of received SMS messages per unit time is measured. When the measured number exceeds a threshold, the user may be notified of the fact that the malicious act-related SMS message is sent (S804 and S806).

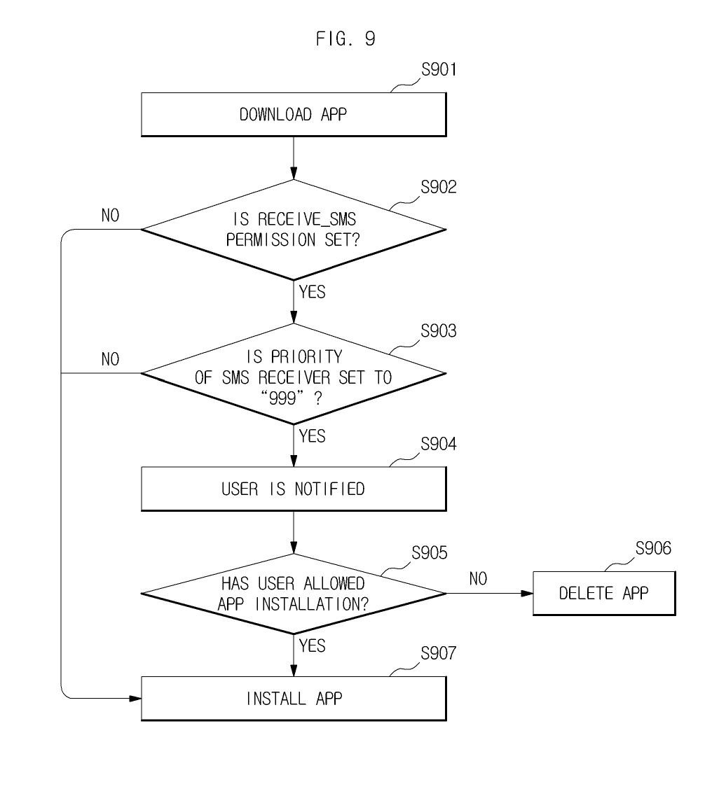

FIG. 9 illustrates a process of determining whether an app to be installed has malware according to an embodiment of the present invention.

When the app is downloaded (S901), the manifest file related to the app is examined to determine whether “RECEIVE_SMS” Permission is set and the priority of the SMS Receiver is set to “999” (S902 and S903).

When “RECEIVE_SMS” Permission is set and the priority of the SMS Receiver is set to “999,” the user is notified of the fact that the app has a possibility of being malware (S904).

The user finally decides whether to install the app (S905). Based on the user's decision, the app may be deleted or installed (S906 and S907).

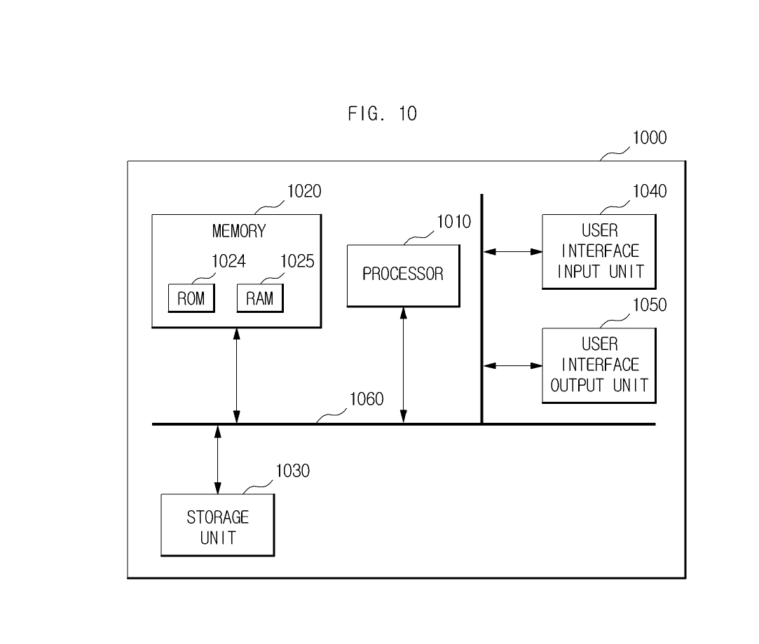

FIG. 10 is a block diagram illustrating a configuration of a smartphone to which an embodiment of the present invention may be applied. As illustrated in FIG. 10, a smartphone 1000 may include at least one component among one or more of processors 1010, a memory 1020, a storage 1030, a user interface input unit 1040, and a user interface output unit 1050, which can communicate through a bus 1060. The processor 1010 may be a CPU or a semiconductor element that executes a processing command stored in the memory 1020 and/or the storage 1030. The memory 1020 and the storage 1030 may include various types of volatile/nonvolatile recording media. For example, the memory may include a ROM 1024 and a RAM 1025.

In one embodiment, the process of detecting the SMS-based malware according to the present invention may be implemented in a program command, stored in the memory 1020, and executed by the processor 1010.

In this way, the apparatus and method according to the embodiments of the present invention may be implemented in a form of the program command that can be performed through various computer units and recorded in computer readable media. The computer readable media may include a program command, a data file, a data structure, or combinations thereof.

The program command recorded in the computer readable media may be specially designed and prepared for the present invention or may be an available well-known command for those skilled in the field of computer software. The computer readable recording media includes a hardware device that is specifically made to store and perform the program command, for example, a hard disk, a floppy disk, and magnetic media such as a magnetic tape, optical media such as a CD-ROM and a DVD, magneto-optical media such as a floptical disk, a ROM, a RAM, a flash memory, and the like. The above media may include transmission media such as a waveguide, a metal strip, or lights including a carrier wave for transmitting a signal designating the program command, the data structure, or the like. Examples of the program command include a machine code generated by a compiler and a high-level language code that can be executed in a computer using an interpreter.

The above hardware device may be configured as at least one software module in order to perform operations of the invention and vice versa.

According to the present invention, when the process of installing the malware and the process of sending and receiving the SMS message are analyzed to detect the SMS-based malware, it is possible to effectively manage SMS-based malware attacks causing billing that are becoming more diverse and intelligent such as an attack using micropayment vulnerability, a premium rate service attack, an excessive SMS sending attack, and a DDoS attack.

While the present invention has been particularly described with reference to exemplary embodiments, it will be understood by those skilled in the art that various changes in form and details may be made without departing from the spirit and scope of the present invention. Therefore, the exemplary embodiments should be considered in a descriptive sense only and not for purposes of limitation. The scope of the invention is defined not by the detailed description of the invention but by the appended claims, and encompasses all modifications and equivalents that fall within the scope of the appended claims and will be construed as being included in the present invention.

What is claimed is:

1. An apparatus for detecting SMS-based malware, comprising:
an SMS collecting module configured to collect an SMS message sent from or received in a smartphone;
an SMS parsing module configured to parse the collected SMS message;
an SMS examining module configured to examine at least one field of the parsed SMS message and determine whether the SMS message is a malicious act-related message based on an access control list (ACL) and an SMS signature DB; and
an installing app examining module configured to examine SMS message sending permission of an app to be installed in the smartphone and a priority of an SMS receiver process included in the app and determine whether the app has a possibility of being malware.

2. The apparatus of claim 1, wherein the ACL includes at least one among a phone number of a premium rate service, a phone number of a command and control server, and a phone number of a smartphone that is already infected with the malware.

3. The apparatus of claim 1, wherein the SMS signature DB stores at least one among a phone number of the smartphone that is already infected with the malware, a micropayment certification number caused by a malicious act, subscription information, subscription confirming information, auto-response information, and billing-related information that are sent and received during a premium rate service attack process, and DDoS attack command information.

4. The apparatus of claim 1, wherein the SMS examining module measures the number of sent or received SMS messages per unit time to detect execution of the malware in the smartphone.

5. The apparatus of claim 1, further comprising
a user determination module configured to receive decision from a user on whether the SMS message determined as the malicious act-related message is blocked and whether the app determined as having a possibility of being malware is deleted.

6. The apparatus of claim 5, further comprising
an SMS filtering module configured to block sending or receiving of the message determined as the malicious act-related message according to the user's decision to block.

7. The apparatus of claim 5, further comprising
an app deleting module configured to delete the app according to the user's decision to delete the app.

8. A method of detecting SMS-based malware, comprising:
collecting an SMS message sent from or received in a smartphone;
parsing the collected SMS message;
examining at least one field of the parsed SMS message and determining whether the SMS message is a malicious act-related message based on an ACL and an SMS signature DB; and
examining SMS message sending permission of an app to be installed in the smartphone and a priority of an SMS receiver process included in the app and determining whether the app has a possibility of being malware.

9. The method of claim 8, wherein the ACL includes at least one among a phone number of a premium rate service, a phone number of a command and control server, and a phone number of a smartphone that is already infected with the malware.

10. The method of claim 8, wherein the SMS signature DB stores at least one among a phone number of the smartphone that is already infected with the malware, a micropayment certification number caused by a malicious act, subscription information, subscription confirming information, auto-response information, and billing-related information that are sent and received during a premium rate service attack process, and DDoS attack command information.

11. The method of claim 8, further comprising
measuring the number of sent SMS messages per unit time; and
determining the SMS message as the malicious act-related message when the number of SMS messages sent to the same destination phone number per unit time exceeds a first threshold.

12. The method of claim 8, further comprising
measuring the number of received SMS messages per unit time; and
determining the SMS message as the malicious act-related message when the number of received SMS messages per unit time exceeds a second threshold.

13. The method of claim 8, further comprising
allowing a user to determine whether the message is blocked when the SMS message is determined as the malicious act-related SMS message.
